(19) United States
(12) Patent Application Publication
(10) Pub. No.: US 2019/0392552 A1
(43) Pub. Date: Dec. 26, 2019

(54) SPINE IMAGE REGISTRATION METHOD

(71) Applicant: National Taiwan University of Science and Technology, Taipei (TW)

(72) Inventors: Ching-Wei Wang, Taipei (TW); Hsin-Ya Ko, Taipei (TW)

(73) Assignee: National Taiwan University of Science and Technology, Taipei (TW)

(21) Appl. No.: 16/109,753

(22) Filed: Aug. 23, 2018

(30) Foreign Application Priority Data
Jun. 22, 2018 (TW) 107121575

(51) Int. Cl. G06T 3/00; G06T 7/00; G06T 7/33; G06T 7/66

(52) U.S. Cl. CPC G06T 3/0068; G06T 7/0012; G06T 7/337; G06T 7/66; G06T 2207/20081; G06T 2207/10084; G06T 2207/10088; G06T 2207/30204; G06T 2207/30012

(57) ABSTRACT

A spine image registration method includes: obtaining a CT image and an MRI image corresponding to a spine; inputting the CT image into a first model to identify at least one first vertebral body of the spine in the CT image; inputting the MRI image to a second model to identify at least one second vertebral body of the spine in the MRI image; marking the first vertebral body with at least one first landmark and marking the second vertebral body with at least one second landmark; matching the first landmark with the second landmark to obtain a corresponding relationship; performing a registration on the CT image and the MRI image according to the corresponding relationship, and generating a registered image according to the content of the CT image and the content of the MRI image located in the same coordinate space; and outputting the registered image.

### CROSS-REFERENCE TO RELATED APPLICATION

This application claims the priority benefit of Taiwan application serial no. 107121575, filed on Jun. 22, 2018. The entirety of the above-mentioned patent application is hereby incorporated by reference herein and made a part of this specification.

### BACKGROUND OF THE INVENTION

### 1. Field of the Invention

The invention relates to an image registration method, and more particularly, to an image registration method for a CT image and an MRI image on the spine.

### 2. Description of Related Art

In the medical field, the CT (Computed Tomography) image may be used to observe hard tissues (e.g., skeleton) in human body. The MRI (Magnetic Resonance Imaging) image may be used to observe soft tissues (nerve or organ) in human body. Before a surgery can be conducted for the patient, the doctor usually needs to obtain the CT image and the MRI image of the patient in order to understand a corresponding relationship between the soft tissues and the hard tissues of the patient, so as to avoid damaging the soft tissues of the patient during the surgery.

In general, an image registration technology aims to integrate data in different coordinate spaces be shown in the same coordinate space. However, said image registration technology is often used for the image of the brain in the medical field. At the present, there is no effective method for applying the image registration technology to the CT image and the MRI image of the spine.

### SUMMARY OF THE INVENTION

The invention is directed to a spine image registration method, which may be used to accurately register the CT image and the MRI image of the spine obtained at different times and/or by different machines so the data of the CT image and the data of the MRI image can be displayed in the same coordinate space to effectively help the development of medical research and the diagnosis of doctors.

The spine image registration method provided by the invention is used for an electronic device. The method includes: obtaining a first CT (Computed Tomography) image and a first MRI (Magnetic Resonance Imaging) image corresponding to a first spine; inputting the first CT image into a first model to identify at least one first vertebral body of the first spine in the first CT image; inputting the first MRI image into a second model to identify at least one second vertebral body of the first spine in the first MRI image; marking the first vertebral body with a first landmark, and marking the second vertebral body with a second landmark; matching the first landmark with the second landmark to obtain a corresponding relationship between the first landmark and the second landmark; performing a registration on the first CT image and the first MRI image according to the corresponding relationship such that a content of the first CT image and a content of the first MRI image are located in a same coordinate space, and generating a registered image according to the content of the first CT image and the content of the first MRI image located in the same coordinate space; and outputting the registered image.

Based on the above, the spine image registration method of the invention may be used to accurately register the CT image and the MRI image of the spine obtained at different times and/or by different machines so the data of the CT image and the data of the MRI image can be displayed in the same coordinate space to effectively help the development of medical research and the diagnosis of doctors.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an electronic device according to an embodiment of the invention.

FIG. 2 is a schematic diagram illustrating a spine detection model generating method and a spine image registration method according to an embodiment of the invention.

FIG. 3 is a schematic diagram illustrating a feature capture performed by using a HOG according to an embodiment of the invention.

FIG. 4 is a schematic diagram illustrating an identified result generated after identifying a vertebral body in a CT image by using a model according to an embodiment of the invention.

FIG. 5 is a schematic diagram illustrating how an erroneous vertebral body is deleted based on a spinal cord according to an embodiment of the invention.

FIG. 6 is a schematic diagram illustrating how a 3D coordinate of a vertebral body in a CT image in a 3D space is determined according to an embodiment of the invention.

FIG. 7 is a schematic diagram illustrating an identified result generated after identifying a vertebral body in an MRI image by using a model according to an embodiment of the invention.

FIG. 8 is a schematic diagram illustrating how a vertebral disc is identified by using a signal strength of reference points according to an embodiment of the invention.

FIG. 9A to FIG. 9C are schematic diagrams illustrating how a 3D coordinate of a vertebral body in an MRI image in a 3D space is determined according to an embodiment of the invention.

FIG. 10 is a schematic diagram illustrating how third vertebral bodies are matched with fourth vertebral bodies according to an embodiment of the invention.

FIG. 11 is a schematic diagram illustrating how first landmarks for matching in a CT image are selected according to an embodiment of the invention.

FIG. 12A to FIG. 12D are schematic diagrams illustrating how second landmarks for matching in an MRI image are selected according to an embodiment of the invention.

FIG. 13 is a flowchart illustrating a spine image registration method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Descriptions of the invention are given with reference to the exemplary embodiments illustrated with accompanied drawings, in which same or similar parts are denoted with same reference numerals. In addition, whenever possible, identical or similar reference numbers stand for identical or similar elements in the figures and the embodiments.

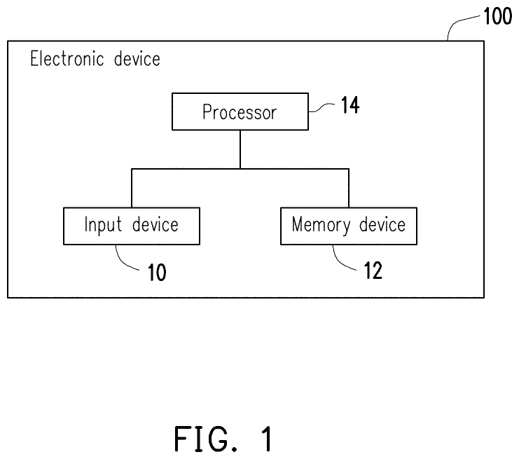

FIG. 1 is a schematic diagram illustrating an electronic device according to an embodiment of the invention. With reference to FIG. 1, an electronic device 100 includes an input device 10, a memory device 12 and a processor 14. The input device 10 and the memory device 12 are respectively coupled to the processor 14. The electronic device 100 may be an electronic device that can access to the Internet, including a smart phone, a tablet computer, a notebook computer, a desktop computer and the like, but not limited thereto.

The input device 10 may be a device for obtaining a CT image and an MRI image. The input device 10 may be, for example, a device capable of scanning the patient by using CT (Computed Tomography) and MRI (Magnetic Resonance Imaging) technologies in order to obtain the CT image and the MRI image. However, in another embodiment, the input device 10 may also be used to obtain the CT image and the MRI image from the memory device 12 of the electronic device 100 or other external memory devices. In yet another embodiment, the input device 10 may also obtain the CT image and the MRI image by other methods. The method for obtaining the CT image and the MRI image used by the input device 10 is not particularly limited by the invention. In this exemplary embodiment, the input device 10 is used to obtain a three dimensional (3D) CT image and a 3D MRI image. It should be noted that, 3D images (e.g., the 3D CT image and the 3D MRI image described above) are data having three dimensions X, Y and Z. In other words, the 3D images are the data within a 3D coordinate space and may be divided into an X-Y plane image, a Y-Z plane image and an X-Z plane image. In this example, the X-Y plane image is an image representing a horizontal plane of human body. Here, the horizontal plane of human body refers a cross-sectional plane formed by upper and lower halves of human body or organ as a result of cutting human body or organ in a horizontal direction. In this example, the Y-Z plane image is an image representing a sagittal plane of human body. Here, the sagittal plane of human body refers a cross-sectional plane formed by left and right halves of human body or organ as a result of cutting human body or organ in an up-down axis direction (i.e., a head-to-toe direction). In this example, the X-Z plane image is an image representing a coronal plane of human body. Here, the coronal plane of human body refers a cross-sectional plane formed by front and back halves of human body or organ as a result of cutting human body or organ in a left-right axis direction. The horizontal plane, the sagittal plane and the coronal plane of human body belong to the definitions of conventional anatomy, which are not repeatedly described hereinafter. In particular, as mentioned in the following content, “the horizontal plane” represents the X-Y plane image in the 3D images; “the sagittal plane” represents the X-Y plane image in the 3D images; and “the coronal plane” represents the X-Z plane image in the 3D images.

The memory device 12 may be a random access memory (RAM), a read-only memory (ROM), a flash memory, a hard Disk drive (HDD), a hard disk drive (HDD) as a solid state drive (SSD) or other similar devices in any stationary or movable form, or a combination of the above-mentioned devices.

The processor 14 may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements.

In this exemplary embodiment, the memory device 12 of the electronic device 100 is stored with a plurality of code segments. After being installed, the code segments may be executed by the processor 14 of the electronic device 100. For example, the memory device 12 of the electronic device 100 is included with a plurality of modules so operations in a spine image registration method can be respectively executed by these modules. Here, each of the modules is composed of one or more program code segments. However, the invention is not limited in this regard. Each of the operations may also be implemented in other hardware manners.

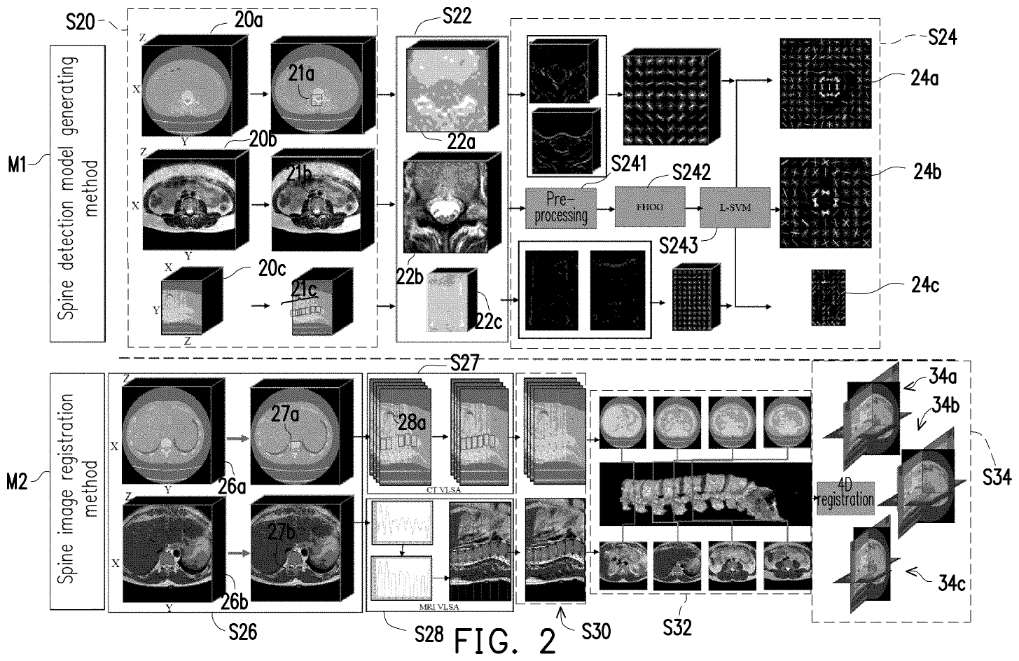

FIG. 2 is a schematic diagram illustrating a spine detection model generating method and a spine image registration method according to an embodiment of the invention.

With reference to FIG. 2, before a spine image registration method M2 can be executed, a spine detection model generating method M1 needs to be executed in order to generate models required in the spine image registration method M2. Here, steps of the spine detection model generating method Ml are described first.

First of all, in step S20, the input device 10 can obtain at least one CT image 20a and a CT image 20c (hereinafter, also known as a second CT image) of a spine (hereinafter, collectively known as a second spine). In this exemplary embodiment, the CT image 20a and the CT image 20c are the 3D CT images. It should be noted that, when the spine in one particular coordinate plane of the 3D CT image is to be detected, the corresponding model needs to be generated by using the CT image of the specific coordinate plane for training before the spine of the specific coordinate plane of the CT image can be detected. For example, the example of FIG. 2 illustrates how a model 24a (a.k.a. a third model) and a model 24c (a.k.a. a fourth model) are trained and generated. The model 24a is used to detect the spine in the X-Y plane (i.e., the horizontal plane) of the 3D CT image, and the model 24c is used to detect the spine in the Y-Z plane (i.e., the sagittal plane) of the 3D CT image. The model 24a and the model 24c may be collectively known as “a first model”.

Further, in step S20, the input device 10 also obtains an MRI image 20b (a.k.a. a second MRI image) of a spine (hereinafter, referred to as a third spine). Here, the third spine may be identical to or different from the second spine described above. In this exemplary embodiment, the MRI image 20b is the 3D MRI image. It should be noted that, when the spine in one specific coordinate plane of the 3D MRI image is to be detected, the corresponding model needs to be generated by using the MRI image of the specific coordinate plane for training before the spine of the specific coordinate plane of the MRI image can be detected. For example, the example of FIG. 2 illustrates how a model 24b (a.k.a. a second model) is trained and generated. The model 24b is used to detect a spine in the X-Y plane (i.e., the horizontal plane) of the 3D MRI image.

Afterwards, vertebral bodies 21a to 21c of the spine may be respectively framed (defined) in the X-Y plane of the CT image 20a, the X-Y plane of the MRI image 20b and the Y-Z plane of the CT image 20c in a manual or automatic fashion. Then, in step S22, images of the vertebral bodies 21a to 21c are captured from the X-Y plane of the CT image 20a, the X-Y plane of the MRI image 20b and the Y-Z plane of the CT image 20c in order to generate training templates 22a to 22c. In other words, the training template 22a is the image of the vertebral body 21a in the X-Y plane of the CT image 20a; the training template 22c is the image of the vertebral body 21c in the Y-Z plane of the CT image 20c; and the training template 22b is the image of the vertebral body 21b in the X-Y plane of the MRI image 20b. Then, the processor 14 executes step S24.

The step may be further subdivided into steps S241 to S243. In step S241, the processor 14 performs a pre-processing operation on the training template 22a and the training template 22c (a.k.a. first training template). The content in the pre-processing operation is not particularly limited by the invention. In step S242, the processor 14 performs a feature capture on these training templates underwent the pre-processing operation to obtain at least one feature (a.k.a. first feature). Then, in step S243, the processor 14 inputs the first feature into a machine learning model for training to generate the model 24a and the model 24c (hereinafter, collectively known as the first model). Here, the model 24a is used to detect the spine in the X-Y plane of the 3D CT image, and the model 24c is used to detect the spine in the Y-Z plane of the 3D CT image.

Similarly, in step S241, the processor 14 also performs the pre-processing operation on the training template 22b (a.k.a. second training template). In step S242, the processor 14 performs the feature capture on said training template underwent the pre-processing operation to obtain at least one feature (a.k.a. second feature). Then, in step S243, the processor 14 inputs the second feature into the machine learning model for training to generate the model 24b. Here, the model 24b is used to detect the spine in the X-Y plane of the 3D MRI image.

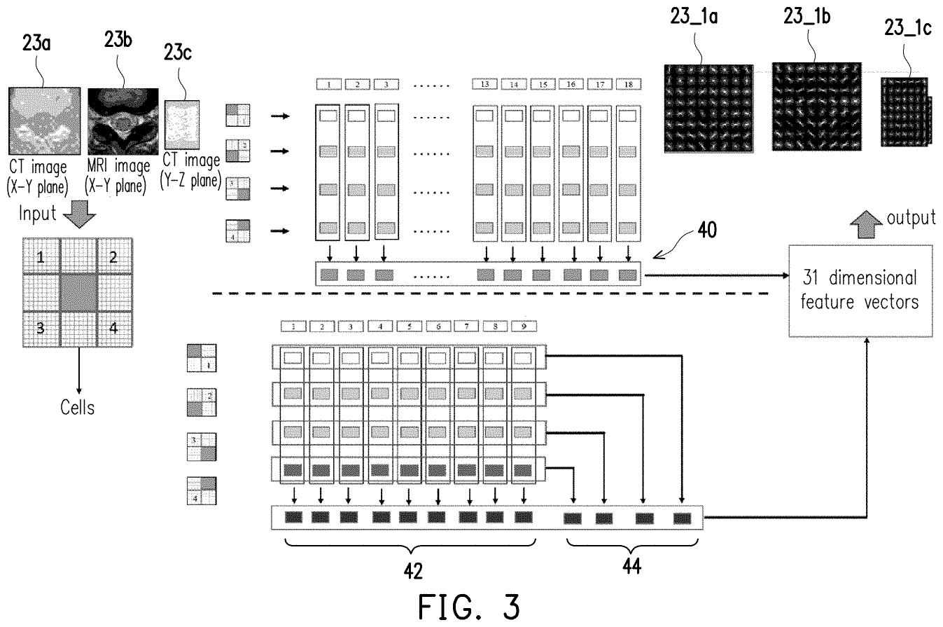

In this exemplary embodiment, the feature capture is performed on the first training template and the second training template underwent the pre-processing operation by using Felzenswalb's Histogram of Oriented Gradient (FHOG) in step S242 in order to obtain the first feature and the second feature having orientation properties. For example, FIG. 3 is a schematic diagram illustrating a feature capture performed by using a HOG according to an embodiment of the invention. With reference to FIG. 3, in this exemplary embodiment, when the feature capture is to be performed by using FHOG, input images (e.g., a CT image 23a, an MRI image 23b an a CT image 23c) needs to be divided into cells first, and the intensities and orientations of the features among the cells are differentiated to generate 18 orientation bins 40 with positive and negative values, 9 orientation bins 42 without positive and negative values and 4 additional orientation bins 44. Accordingly, output images with 31 dimensional feature vectors (e.g., an output image 23_1a corresponding to the CT image 23a, an output image 23_1b corresponding to the MRI image 23b and an output image 23_1c corresponding to the CT image 23c) may then be generated from the input CT images and the MRI image. The calculation using FHOG may refer to the known method in conventional art, which is not repeated herein.

In addition, referring back to FIG. 2, the machine learning model used in step S243 is Linear Support Vector Machine (L-SVM). However, in other embodiments, other feature capture algorithms may also be used in step S242, and other models may also be used as the machine learning model in step S243.

When the models are completely trained, the processor 14 can execute the spine image registration method M2. Detailed steps in the spine image registration method M2 are described as follows.

First of all, in step S26 of FIG. 2, the input device 10 obtains a 3D CT image 26a (a.k.a. a first CT image) and a 3D MRI image 26b (a.k.a. a first MRI image) to be registered. Here, the CT image 26a and the MRI image 26b are images corresponding to a spine (a.k.a. a first spine) of the same person.

After obtaining the CT image 26a and the MRI image 26b to be registered, the processor 14 can input a plurality of X-Y plane images of the CT image 26a (i.e., a plurality of X-Y plane images having different values in the Z coordinate) into aforesaid model 24a to identify (or frame) a spine position 27a in the X-Y plane (hereinafter, referred to as a first horizontal plane) of the CT image 26a, and identify a spine center point (a.k.a. a first spine center point) of the first spine of each of the X-Y plane images in the CT image 26a according to the spine position 27a. In addition, the processor 14 can input a plurality of X-Y plane images of the MRI image 26b (i.e., a plurality of X-Y plane images having different values in the Z coordinate) into aforesaid model 24b to identify (or frame) a spine position 27b in the X-Y plane (hereinafter, referred to as a second horizontal plane) of the MRI image 26b, and identify a spine center point (a.k.a. a second spine center point) of the first spine of each of the X-Y plane images in the MRI image 26b according to the spine position 27b.

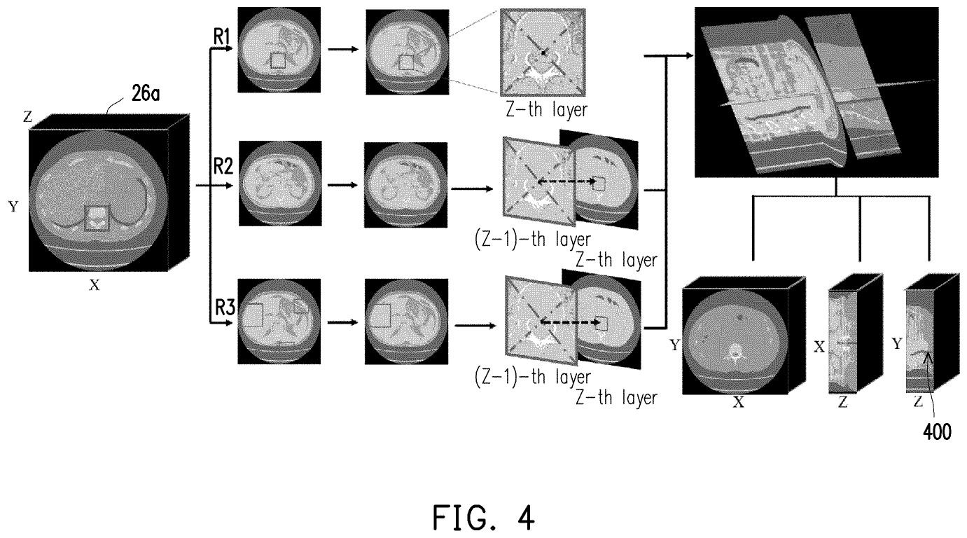

Next, in step S27, the processor 14 executes Vertebra Localization Signal Analysis (VLSA) applicable to the CT image so as to optimize an identified result of the vertebral body. For example, FIG. 4 is a schematic diagram illustrating an identified result generated after identifying a vertebral body in a CT image by using a model according to an embodiment of the invention. With reference to FIG. 4, in this exemplary embodiment, there may be three determination results R1 to R3 after one particular X-Y plane image of the CT image 26a is input into the model 24a. As shown in FIG. 4, it is assumed that, after the X-Y plane image at a z-th layer of the 3D CT image is input into the model 24a for determination, it means that the vertebral body (or the spine) in the CT image is correctly identified if the determination result R1 is obtained. However, if the determination result R2 is obtained, it means that no vertebral body is identified in the CT image. In this case, the processor 14 may use an image at a (z−1)-th layer (or a (z+1)-th layer) adjacent to the z-th layer to correct the CT image at the z-th layer, so as to identify the vertebral body in the CT image at the z-th layer. Further, if the determination result R3 is obtained, it means that a non-vertebral body part in the CT image is mistakenly determined as the vertebral body. In this case, the processor 14 may use an image at a (z−1)-th layer (or a (z+1)-th layer) adjacent to the z-th layer to correct the CT image at the z-th layer, so as to identify the vertebral body in the CT image at the z-th layer. After the vertebral body is being identified, a box may be used to frame the vertebral body, and a reference point may be used to mark a center point of the box so the spine center point can be represented by the reference point. After multiple said reference points are respectively used to mark the spine center points in the X-Y plane images of the CT image 26a, the X and Y coordinates of each of the reference points can be obtained. According to the Y coordinate of each of the reference points and the Z coordinate of each of the reference points in the X-Y plane, the coordinate of each of the reference points in the Y-Z plane may be obtained. In particular, because the coordinates for marking of the reference points in the Y-Z plane are continuous with each other, one continuous reference line 400 (a.k.a. a first reference line) composed of said reference points in the Y-Z plane (hereinafter, referred to as a first sagittal plane) of the CT image 26a may then be obtained.

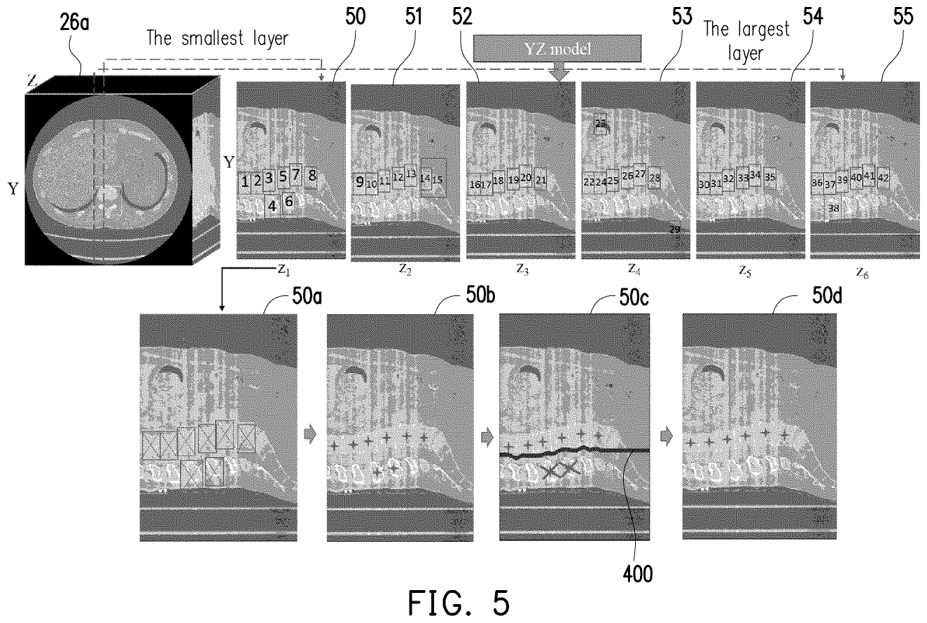

Next, FIG. 5 is a schematic diagram illustrating how an erroneous vertebral body is deleted based on a spinal cord according to an embodiment of the invention. With reference to FIG. 5, the processor 14 may also find a range of these X coordinates according to the X coordinates of the reference points, and capture a plurality of Y-Z plane images of the CT image 26a (i.e., a plurality of Y-Z plane images having different values in the X coordinate). As shown in FIG. 5, it is assumed that, the processor 14 captures images 50 to 55 according to said range of the X coordinates, and inputs the images 50 to 55 into the model 24c to identify vertebral bodies of the first spine (a.k.a. first vertebral bodies) in the Y-Z plane images (i.e., the images 50 to 55) of the CT image 26a.

Taking the image 50 in the Y-Z plane of the CT image 26a within a Z coordinate range Z₁ as an example, after the image 50 is input into the model 24, the processor 14 uses boxes to frame the vertebral bodies of the spine in the image 50 and numbers the boxes (e.g., by numbers 1 to 8). Afterwards, the processor 50 finds the center points of the boxes. As shown by an image 50a, the processor 14 finds the center point of each of the boxes according to, for example, diagonal lines of each of the boxes. The processor 14 can mark down the center pint of each of the boxes, as shown by an image 50b. Afterwards, as shown by an image 50c, the processor 14 identifies an erroneous vertebral body (hereinafter, also referred to as a first erroneous vertebral body) according to the first reference line 400 found through the reference points and the marked center point of each of the boxes. For example, if the center point of one particular box is below the first reference line 400, a target framed by that particular box corresponding to the center point may then be identified as the erroneous vertebral body. Lastly, as shown by an image 50d, after the erroneous vertebral body is deleted, the center points of the remaining boxes can represent the vertebral bodies of the first spine with the erroneous vertebral body being excluded.

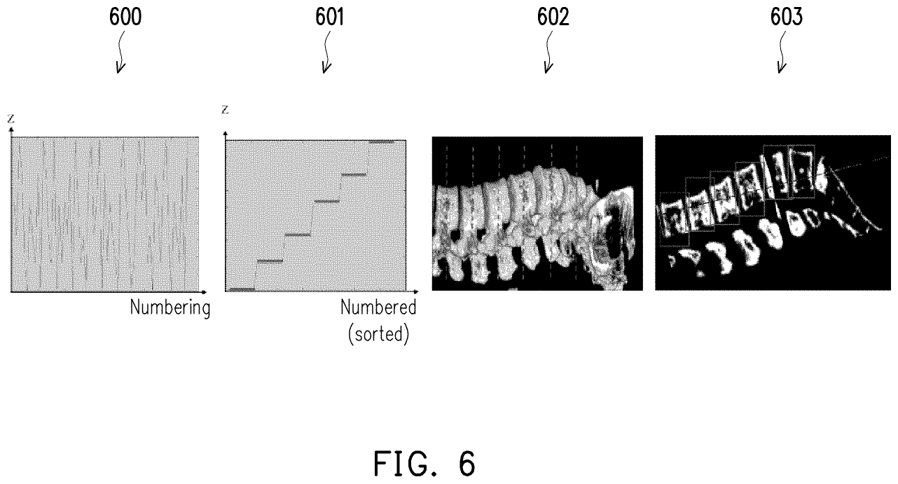

Afterwards, FIG. 6 is a schematic diagram illustrating how a 3D coordinate of a vertebral body in a CT image in a 3D space is determined according to an embodiment of the invention.

With reference to FIG. 6, after the steps of framing the vertebral bodies by the boxes and deleting the erroneous vertebral bodies are performed for each of the images 50 to 55, the processor 14 may obtain a value (a.k.a. a first coordinate value) of the center point of each of the boxes in the Z coordinate (a.k.a. a first dimension) in the images 50 to 55, and create a statistical graph 600 according to the value of the center point of each of the boxes in the Z coordinate and the numbers of the boxes. Afterwards, the processor 14 sorts the numbers of the boxes according to the value of the center point of each of the boxes in the Z coordinate, so as to sort the numbers of the boxes having the same value in the Z coordinate together, as shown by a statistical graph 601. In particular, if the boxes in the different images have similar (or identical) values in the Z coordinate, it means that those boxes are corresponding to the same vertebral body. Accordingly, a plurality of values (a.k.a. second coordinate values) in the Z coordinate may be obtained according to the statistical graph 601, and these second coordinate values are the values of the center points of the vertebral bodies in the Z coordinate in the 3D space respectively. As shown by an image 602, the second coordinate values are the center points corresponding to the vertebral bodies. For each coordinate value among the second coordinate values, the processor 14 finds the X-Y plane to which that coordinate value belongs, and uses values of the X coordinate and the Y coordinate of the spine center point identified by the model 24a in the X-Y plane to which that coordinate value belongs as values of the X coordinate and the Y coordinate in the 3D coordinate, so as to obtain the 3D coordinate of the center point of each of the vertebral bodies in the CT image 26a in the 3D space.

For instance, it assumed that one particular coordinate value among the second coordinate values is 5 (i.e., the value in the Z coordinate is 5), the processor 14 then finds the X-Y plane with the value in the Z coordinate being 5 from the CT image 26a, and uses values of the X coordinate and the Y coordinate of the spine center point identified by the model 24 in said X-Y plane as the values of the X coordinate and the Y coordinate in the 3D coordinate. In other words, by using this method, the values of the X coordinate and the Y coordinate of the vertebral body with the value in the Z coordinate being 5 may be found to thereby obtain the 3D coordinate of that vertebral body in the 3D space. An image 603 mainly illustrates a corresponding relationship between the 3D coordinate of each vertebral body in the 3D space and the respective vertebral body.

Referring back to FIG. 2, in step S28, the processor 14 executes Vertebra Localization Signal Analysis applicable to the MRI image so as to optimize an identified result of the vertebral body.

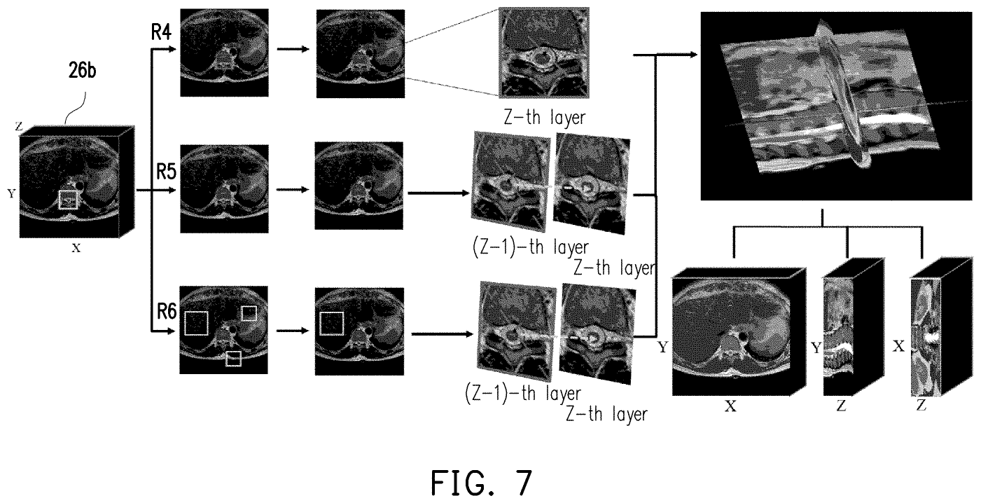

For example, FIG. 7 is a schematic diagram illustrating an identified result generated after identifying a vertebral body in an MRI image by using a model according to an embodiment of the invention. Referring to FIG. 7, in this exemplary embodiment, with the X-Y plane images in the MRI image 26b taken as an example, there may be three determination results R4 to R4 after the MRI image 26b is input into the model 24b. As shown in FIG. 6, it is assumed that, after the X-Y plane image at a z-th layer of the 3D MRI image is input into the model 24b for determination, it means that the vertebral body in the MRI image is correctly identified if the determination result R4 is obtained. However, it means that no vertebral body is identified in the MRI image if the determination result R5 is obtained. In this case, the processor 14 may use an image at a (z−1)-th layer (or a (z+1)-th layer) adjacent to the z-th layer to correct the vertebral body in the MRI image at the z-th layer, so as to identify the vertebral body in the MRI image at the z-th layer. Further, if the determination result R6 is obtained, it means that a non-vertebral body part in the MRI image mistakenly determined as the vertebral body. In this case, the processor 14 may use an image at a (z−1)-th layer (or a (z+1)-th layer) adjacent to the z-th layer to correct the MRI image at the z-th layer, so as to identify the vertebral body in the MRI image at the z-th layer. After the vertebral body is being identified, a box may be used to frame the vertebral body, and a reference point may be used to mark a center point of the box so the spine center point can be represented by the reference point. After multiple said reference points are respectively used to mark the spine center points in the X-Y plane images of the MRI image 26b, the X and Y coordinates of each of the reference points can be obtained. According to the Y coordinate of each of the reference points and the Z coordinate of each of the reference points in the X-Y plane, the coordinate of each of the reference points in the Y-Z plane may be obtained. In particular, because the coordinates of the reference points on the Y-Z plane are continuous with each other, one continuous reference line (a.k.a. a second reference line) composed of said reference points in the Y-Z plane (hereinafter, referred to as a second reference point) of the MRI image 26b may then be obtained.

Further, in step S28 of FIG. 2, the processor 14 also identifies a vertebral disc of the first spine in the MRI image 26b according to a signal strength of the reference points on the second reference line. The processor 14 identifies the 3D coordinate of a second vertebral body in the 3D space according to the identified vertebral disc.

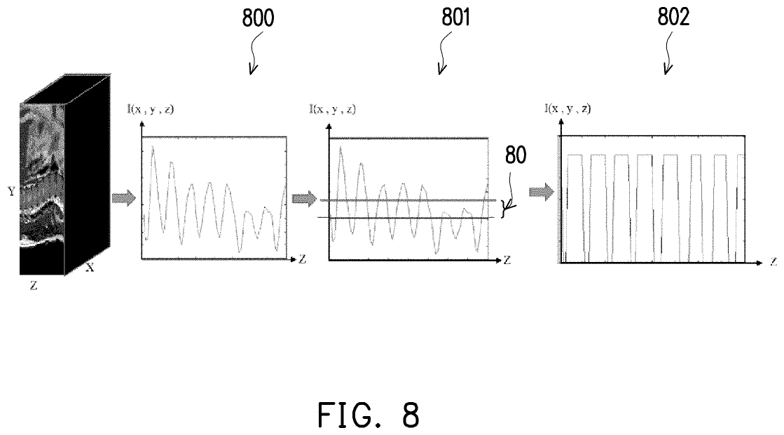

Specifically, FIG. 8 is a schematic diagram illustrating how a vertebral disc is identified by using a signal strength of reference points according to an embodiment of the invention.

With reference to FIG. 8, the processor 14 further creates a statistical graph 800 by the signal strength of all the reference points on the second reference point line and the values of the reference points in the Z coordinate. Afterwards, the processor 14 may select, for example, signals with the signal strength within an interval 80 in the statistical graph 800 for binarization, and generate a result as shown by a statistical graph 802.

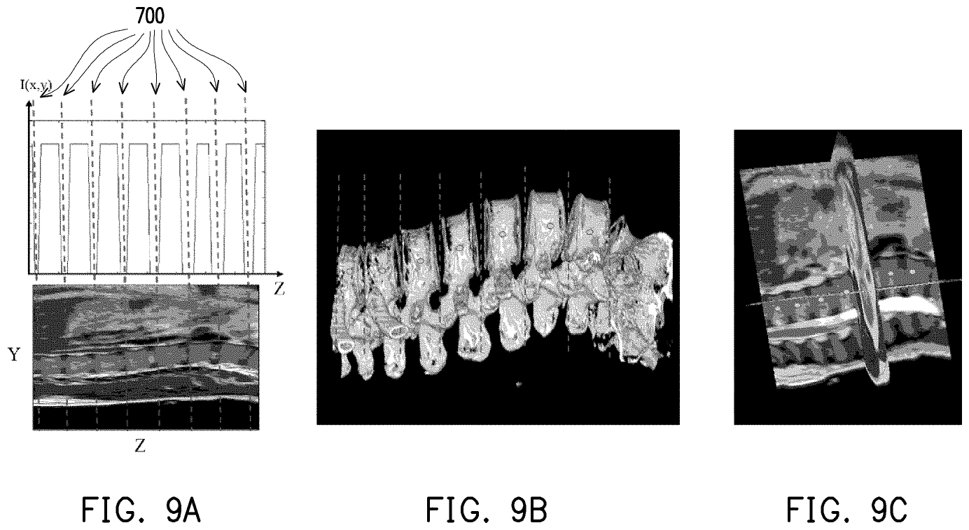

Further, FIG. 9A to FIG. 9C are schematic diagrams illustrating how a 3D coordinate of a vertebral body in an MRI image in a 3D space is determined according to an embodiment of the invention.

With reference to FIG. 9A to FIG. 9C, the processor 14 identifies portions belonging to the signal strength of 0 in the statistical graph 802 as the vertebral discs of the spine in the MRI image. For example, dotted lines 700 in FIG. 9A indicate the portions belonging to the signal strength of 0 in the statistical graph 802, which are corresponding to the vertebral discs in the Y-Z plane images of the MRI image 26b. The vertebral body is a portion between two adjacent vertebral discs. As shown in FIG. 9B, the processor 14 can treat a center point of a distance between the two adjacent vertebral discs as a value (a.k.a. a third coordinate value) in the Z coordinate (a.k.a. the first dimension) of the center point of the vertebral body between said two vertebral discs. As shown in FIG. 9B, the third coordinate value is corresponding to the center point of each of the vertebral bodies (a.k.a. the second vertebral body). For each coordinate value among the third coordinate values, the processor 14 finds the X-Y plane to which that coordinate value belongs, and uses values of the X coordinate and the Y coordinate of the spine center point identified by the model 24b in the X-Y plane to which that coordinate value belongs as values of the X coordinate and the Y coordinate in the 3D coordinate, so as to obtain the 3D coordinate of the center point of each of the vertebral bodies in the MRI image 26b in the 3D space. FIG. 9C shows the 3D coordinate of the center point of each of the vertebral bodies in the MRI image 26b in the 3D space in a 3D fashion.

Referring back to FIG. 2, in step S30, the processor 14 marks each of the vertebral bodies in the MRI image 26b with a landmark according to the 3D coordinate of the center point of each of the vertebral bodies in the CT image 26a in the 3D space. Also, the processor 14 marks each of the vertebral bodies in the MRI image 26b with a landmark according to the 3D coordinate of the center point of each of the vertebral bodies in the MRI image 26b in the 3D space.

Afterwards, in step S32, the processor 14 selects a plurality of vertebral bodies for matching (a.k.a. third vertebral bodies) from the CT image 26a, and selects a plurality of vertebral bodies for matching (a.k.a. fourth vertebral bodies) from the MRI image 26b. Here, the third vertebral bodies are respectively corresponding to the fourth vertebral bodies.

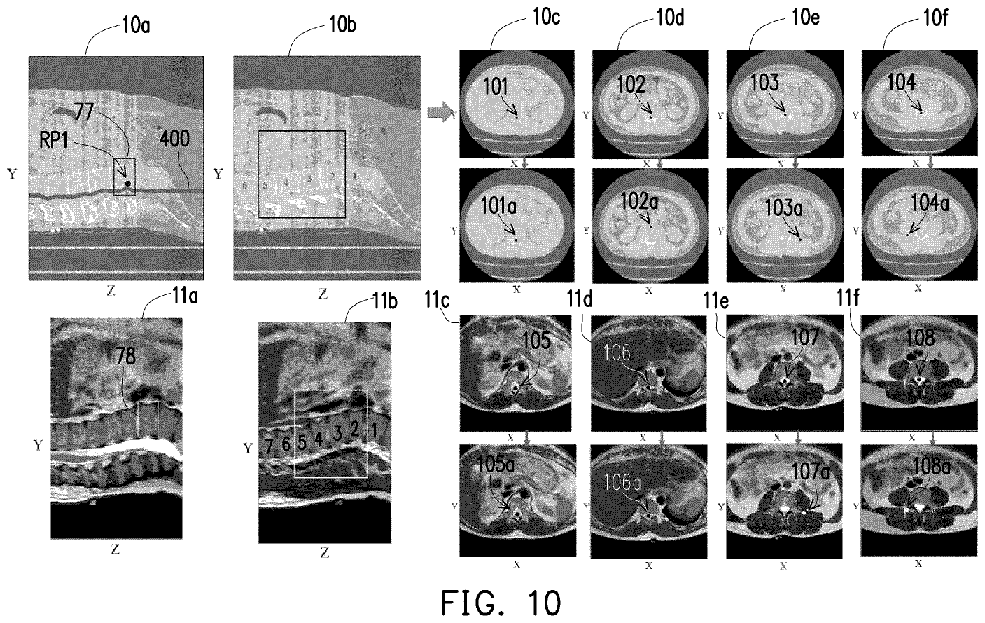

Specifically, FIG. 10 is a schematic diagram illustrating how third vertebral bodies are matched with fourth vertebral bodies according to an embodiment of the invention.

With reference to FIG. 10, as shown by an image 10a and an image 10b, the processor 14 selects a vertebral body 77 (a.k.a. a fifth vertebral body) numbered by 2 from the X-Y plane images of the CT image 26a, for example. Here, the vertebral body 77 includes a reference point RP1 (a.k.a. a first reference point) on the reference line 400, and a value of this reference point RP1 in the Y coordinate is greater than values of the other reference points on the reference line 400 in the Y coordinate. Based on the selected vertebral body 77, the processor 14 selects a plurality of consecutive vertebral bodies (a.k.a. the third vertebral bodies) in the CT image 26a, including the vertebral body 77. For example, the processor 14 selects the vertebral bodies numbered by 2 to 5 in the CT image 26a.

In addition, as shown by an image 11a and an image 11b, the processor 14 further selects a vertebral body 78 (a.k.a. a sixth vertebral body) numbered by 2 from the MRI image 26b. Here, the vertebral body 78 includes one reference point (a.k.a. a second reference point, not illustrated) on the second reference line, and a value of this second reference point in the Y coordinate is greater than values of the other reference points on the second reference line in the Y coordinate. Based on the selected vertebral body 78, the processor 14 selects a plurality of consecutive vertebral bodies (a.k.a. the fourth vertebral bodies) in the MRI image 26b, including the vertebral body 78. For example, the processor 14 selects the vertebral bodies numbered by 2 to 5 in the MRI image 26b.

After selecting the third vertebral bodies for matching in the CT image 26a and the fourth vertebral bodies for matching in the MRI image 26b, the processor 14 marks the third vertebral bodies with a plurality of first landmarks and marks the fourth vertebral bodies with a plurality of second landmarks. Then, the processor 14 matches the first landmarks with the second landmarks to obtain a corresponding relationship between the first landmark and the second landmark for a registration of the images.

More specifically, it is assumed that, an image 10c is an image of a spine center point 101 of the vertebral body numbered by 2 in the X-Y plane of the image 10b; an image 10d is an image of a spine center point 102 of the vertebral body numbered by 3 in the X-Y plane of the image 10b; an image 10e is an image of a spine center point 103 of the vertebral body numbered by 4 in the X-Y plane of the image 10b; and an image 10f is an image of a spine center point 104 of the vertebral body numbered by 5 in the X-Y plane of the image 10b. The processor 14 marks the images 10c to 10f respectively with a landmark 101a, a landmark 102a, a landmark 103a and a landmark 104a according to the 3D coordinates of the spine center points 101 to 104, so as to mark the vertebral bodies numbered by 2 to 5 respectively with the landmarks. Here, the landmark 101a, the landmark 102a, the landmark 103a and the landmark 104a are non-coplanar to each other.

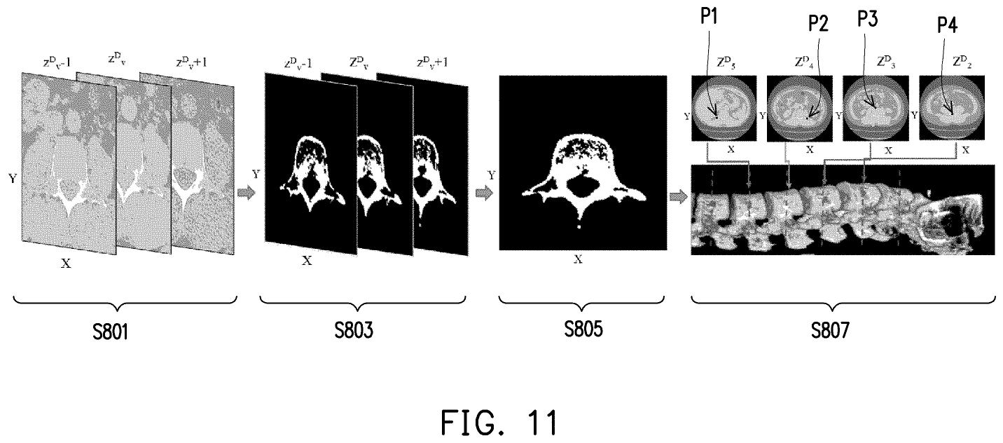

Specifically, FIG. 11 is a schematic diagram illustrating how first landmarks for matching in a CT image are selected according to an embodiment of the invention. With reference to FIG. 11, the processor 14 obtains a plurality of CT images (e.g., the X-Y plane image at (Z^{D}_{V}−1)-th to (Z^{D}_{V}+1)-th layers in the 3D CT image) in step S801, for example. Next, in step S803, a max-entropy threshold and a two dimensional medium filter are used to remove noises and erroneous structures. Afterwards, in step S805, a union of the images processed through step S803 is computed. For example, the processor 14 computes the union of the X-Y plane images at the (Z^{D}_{V}−1)-th to (Z^{D}_{V}+1)-th layers in the 3D CT image processed through step S803, and generates one union image in step S805. According to the union image generated in step S805, landmarks for matching in different vertebral bodies may be selected in step S807. Here, the landmarks for matching may be landmarks non-coplanar to each other in the different vertebral bodies of the same spine. For example, according to the union image in step S805, the processor 14 can select a landmark P1 on the leftmost side of the vertebral body in the X-Y plane image at the (Z^{D}₅)-th layer of the 3D CT image, a landmark P2 on the rightmost side of the vertebral body in the X-Y plane image at the (Z^{D}₄)-th layer of the 3D CT image, a landmark P3 on the uppermost side of the vertebral body in the X-Y plane image at the (Z^{D}₃)-th layer of the 3D CT image and a landmark P4 on the lowermost side of the vertebral body in the X-Y plane image at the (Z^{D}₂)-th layer of the 3D CT image, and perform a subsequent matching according to the landmarks P1 to P4. The method for generating the landmarks P1 to P4 in FIG. 11 is applicable to generate the landmark 101a, the landmark 102a, the landmark 103a and the landmark 104a described above.

Referring back to FIG. 10, it is assumed that, an image 11c is an image of a spine center point 105 of the vertebral body numbered by 2 in the X-Y plane of the image 11b; an image 11d is an image of a spine center point 106 of the vertebral body numbered by 3 in the X-Y plane of the image 11b; an image 11e is an image of a spine center point 107 of the vertebral body numbered by 4 in the X-Y plane of the image 11b; and an image 11f is an image of a spine center point 108 of the vertebral body numbered by 5 in the X-Y plane of the image 11b. The processor 14 marks the images 11c to 11f respectively with a landmark 105a, a landmark 106a, a landmark 107a and a landmark 108a according to the 3D coordinates of the spine center points 105 to 108, so as to mark the vertebral bodies numbered by 2 to 5 with the landmarks. Here, the landmark 105a, the landmark 106a, the landmark 107a and the landmark 108a are non-coplanar to each other.

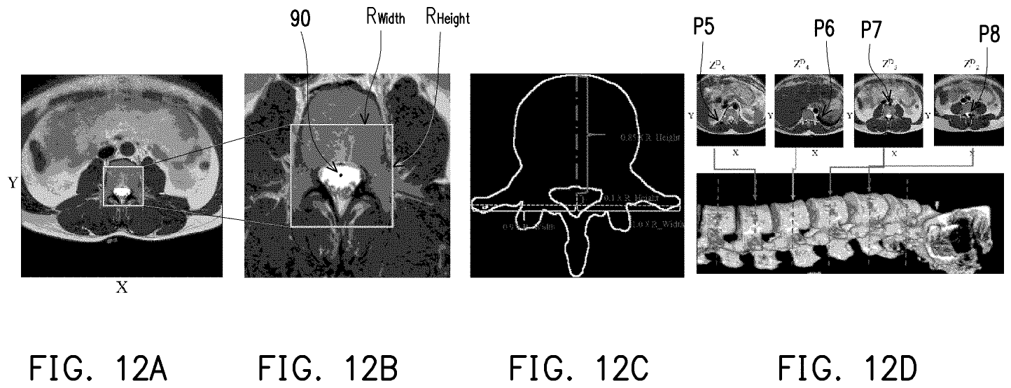

In detail, FIG. 12A to FIG. 12D are schematic diagrams illustrating how second landmarks for matching in an MRI image are selected according to an embodiment of the invention. With reference to FIG. 12A and FIG. 12D, for example, the processor 14 obtains the MRI image of FIG. 12A (e.g., one of the images 11c to 11f) and this MRI image includes a vertebral body identified by the model 24b. This vertebral body is marked with a rectangle having a width R_{Width} and a height R_{Height} (as shown by FIG. 12B), and lengths of the width R_{Width} and the height R_{Height} are obtained from the model 24b. According to the rectangle having the width R_{Width} and the height R_{Height}, a center point 90 of a spine in the MRI image identified by the model 24b may be found, and a coordinate of the center point 90 of the spine may be defined as I(ϕ,φ). As shown in FIG. 12C, a plurality of coordinate points of a spine image may be defined according to I(ϕ,φ). For example, the coordinate points include a coordinate point with x coordinate being ϕ−0.9 R_{Width} and y coordinate being φ+0.1 R_{Height}, a coordinate point with x coordinate being ϕ+1.0 R_{Width} and y coordinate being φ+0.1 R_{Height} in the spine image, and a coordinate point with x coordinate being ϕ and y coordinate being 100 +0.1 R_{Height} in the spine image. The processor 14 can select the landmarks for matching in the different vertebral bodies according to the coordinate points in said spine image. Here, the landmarks for matching may be landmarks non-coplanar to each other in the different vertebral bodies of the same spine. For example, according to the coordinate points in the spine image, the processor 14 can select a landmark P5 on the leftmost side of the X-Y plane image at the (Z^{D}₅)-th layer of the 3D MRI image, a landmark P6 on the rightmost side of the X-Y plane image at the (Z^{D}₄)-th layer of the 3D MRI image, a landmark P7 on the uppermost side of the X-Y plane image at the (Z^{D}₃)-th layer of the 3D MRI image and a landmark P8 on the lowermost side of the X-Y plane image at the (Z^{D}₂)-th layer of the 3D MRI image, and performs a subsequent matching according to the landmarks P5 to P8. The method for generating the landmarks P5 to P5 in FIG. 12A to FIG. 12D is applicable to generate the landmark 105a, the landmark 106a, the landmark 107a and the landmark 108a described above.

Referring back to FIG. 10, the landmark 101a, the landmark 102a, the landmark 103a and the landmark 104a are respectively corresponding to the landmark 105a, the landmark 106a, the landmark 107a and the landmark 108a. In other words, there is a corresponding relationship between the landmark 101a, the landmark 102a, the landmark 103a, the landmark 104a and the landmark 105a, the landmark 106a, the landmark 107a, the landmark 108a.

In other words, step S32 of FIG. 2 is mainly used to find the first landmarks and the second landmarks for matching. Here, the first landmarks and the second landmarks are corresponding to the same vertebral body in the first spine. Afterwards, the processor 14 matches the first landmarks with the second landmarks so as to obtain the corresponding relationship.

Next, in step S34, the processor 14 performs a four dimensional (4D) registration on the CT image 26a and the MRI image 26b according to the corresponding relationship between the first landmark and the second landmark such that a content of the CT image 26a and a content of the MRI image 26b are located in a same coordinate space. In this exemplary embodiment, the processor 14 registers data of the MRI image 26b into a coordinate space of the CT image 26a according to the corresponding relationship obtained in step S32. Next, the processor 14 generates a registered image 34a, registered image 34b, or a registered image 34c according to the content of the CT image 26a and the content of the MRI image 26b located in the same coordinate space. The processor 14 can output the registered image 34a, the registered image 34b or the registered image 34c to an output device (e.g., a screen, not illustrated) for the user to view.

In this exemplary embodiment, the step of performing the registration on the CT image and the MRI image includes performing a global registration and a local registration. The global registration is mainly used to roughly match the landmarks selected from the two images according to said corresponding relationship, and register the landmarks to the same coordinate space. The global registration may include operations like translation, rotate and scaling. The local registration is mainly used to perform a more detailed organization on a result of the global registration so as to generate a more accurate registration result. The global registration includes a SVD (Singular Value Decomposition) algorithm, and the local registration includes at least one of Affine Transformation and B-Spline Transformation. In this exemplary embodiment, a more preferable global registration method is to use both Affine Transformation and B-Spline Transformation at the same time. Here, the registered image 34a is a result generated by the registration using Affine Transformation; the registered image 34b is a result generated by the registration using B-Spline Transformation; and the registered image 34c is a result generated by the registration using both Affine Transformation and B-Spline Transformation at the same time.

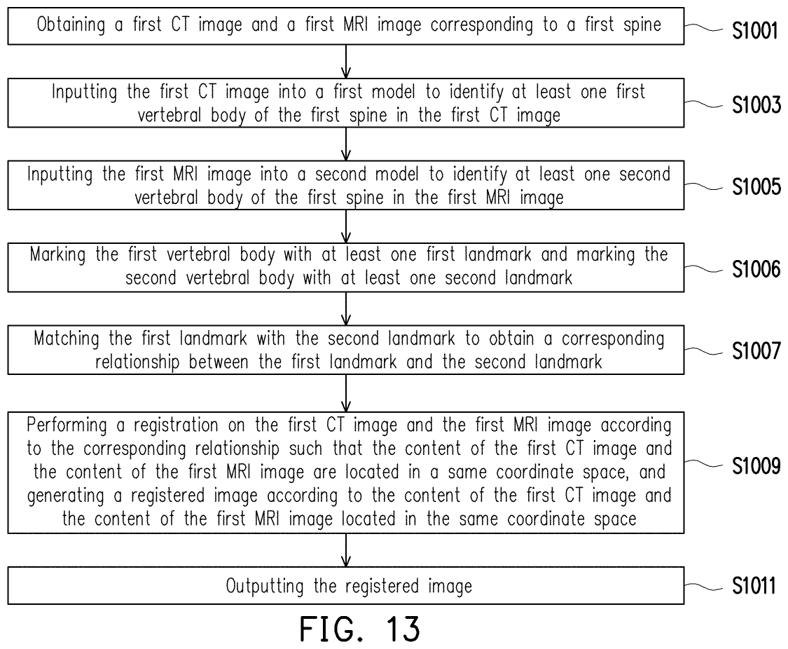

FIG. 13 is a flowchart illustrating a spine image registration method according to an embodiment of the invention. With reference to FIG. 13, in step S1001, the processor 14 obtains a first CT image and a first MRI image corresponding to a first spine. In step S1003, the processor 14 inputs the first CT image into a first model to identify at least one first vertebral body of the first spine in the first CT image. In step S1005, the processor 14 inputs the first MRI image into a second model to identify at least one second vertebral body of the first spine in the first MRI image. In step S1006, the processor 14 marks the first vertebral body with a first landmark and marks the second vertebral body with a second landmark. In step S1007, the processor 14 matches the first landmark with the second landmark to obtain a corresponding relationship between the first landmark and the second landmark. In step S1009, the processor 14 performs a registration on the first CT image and the first MRI image according to the corresponding relationship such that a content of the first CT image and a content of the first MRI image are located in a same coordinate space, and generates a registered image according to the content of the first CT image and the content of the first MRI image located in the same coordinate space. Lastly, in step S1011, the processor 14 outputs the registered image.

In summary, the spine image registration method of the invention may be used to accurately register the CT image and the MRI image of the spine obtained at different times and/or by different machines so the data of the CT image and the data of the MRI image can be displayed in the same coordinate space to effectively help the development of medical research and the diagnosis of doctors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A spine image registration method for an electronic device, the method comprising:
obtaining a first CT (Computed Tomography) image and a first MRI (Magnetic Resonance Imaging) image corresponding to a first spine;
inputting the first CT image into at least one first model to identify at least one first vertebral body of the first spine in the first CT image;
inputting the first MRI image into a second model to identify at least one second vertebral body of the first spine in the first MRI image;
marking the at least one first vertebral body with at least one first landmark, and marking the at least one second vertebral body with at least one second landmark;
matching the at least one first landmark with the at least one second landmark to obtain a corresponding relationship between the at least one first landmark and the at least one second landmark;
performing a registration on the first CT image and the first MRI image according to the corresponding relationship such that a content of the first CT image and a content of the first MRI image are located in a same coordinate space, and generating a registered image according to the content of the first CT image and the content of the first MRI image located in the same coordinate space; and
outputting the registered image.

2. The spine image registration method according to claim 1, wherein before the step of inputting the first CT image into the at least one first model, the method further comprises:
obtaining at least one second CT image corresponding to a second spine, and obtaining at least one first training template corresponding to the second spine in the at least one second CT image;
performing a feature capture on the first training template to obtain at least one first feature; and
inputting the at least one first feature into a machine learning model for training to generate the at least one first model.

3. The spine image registration method according to claim 1, wherein before the step of inputting the first MRI image into the second model, the method further comprises:
obtaining at least one second MRI image corresponding to a third spine, and obtaining at least one second training template corresponding to the third spine in the at least one second MRI image;
performing a feature capture on the at least one second training template to obtain at least one second feature; and
inputting the at least one second feature into a machine learning model for training to generate the second model.

4. The spine image registration method according to claim 1, wherein the at least one first model comprises a third model and a fourth model, wherein the step of inputting the first CT image into the at least one first model to identify the at least one first vertebral body of the first spine in the first CT image comprises:
inputting the first CT image into the third model to identify a first spine center point of the first spine in a first horizontal plane of the first CT image;
obtaining a first reference line in a first sagittal plane of the first CT image according to the first spine center point;
inputting the first CT image into the fourth model to identify the at least one first vertebral body of the first spine in the first sagittal plane of the first CT image;
identifying a first erroneous vertebral body in the at least one first vertebral body according to the first reference line and the at least one first vertebral body in the first sagittal plane; and
deleting the first erroneous vertebral body in the at least one first vertebral body.

5. The spine image registration method according to claim 4, wherein the step of inputting the first CT image into the fourth model to identify the at least one first vertebral body of the first spine in the first sagittal plane of the first CT image comprises:
framing the at least one first vertebral body respectively by at least one box, wherein after the step of deleting the first erroneous vertebral body in the at least one first vertebral body, the method further comprises:
obtaining a first coordinate value of a center point of each of the at least one box in a first dimension, identifying a second coordinate value of a center point of each of the at least one first vertebral body in the first dimension by sorting according to the first coordinate value, and obtaining a three dimensional (3D) coordinate of the center point of each of the at least one first vertebral body in a 3D space according to the second coordinate value.

6. The spine image registration method according to claim 5, wherein the step of inputting the first MRI image into the second model to identify the at least one second vertebral body of the first spine in the first MRI image comprises:
inputting the first MRI image into the second model to identify a second spine center point of the first spine in a second horizontal plane of the first MRI image;
obtaining a second reference line in a second sagittal plane of the first MRI image according to the second spine center point;
identifying at least one vertebral disc of the first spine in the second sagittal plane of the first MRI image according to a signal strength of a plurality of reference points on the second reference line; and
obtaining a third coordinate value of a center point of each of the at least one second vertebral body in the first dimension according to the vertebral disc, and obtaining the 3D coordinate of the center point of each of the at least one second vertebral body in the 3D space according to the third coordinate value.

7. The spine image registration method according to claim 6, wherein the step of marking the at least one first vertebral body with the at least one first landmark and marking the at least one second vertebral body with the at least one second landmark comprises:
selecting a plurality of third vertebral bodies in the at least one first vertebral body;
selecting a plurality of fourth vertebral bodies in the at least one second vertebral body, wherein the third vertebral bodies are respectively corresponding to the fourth vertebral bodies;
marking the third vertebral bodies respectively with the at least one first landmark according to the 3D coordinate of a center point of each of the third vertebral bodies in the 3D space, wherein the at least one first landmark is non-coplanar to each other;
marking the fourth vertebral bodies respectively with the at least one second landmark according to the 3D coordinate of a center point of each of the fourth vertebral bodies in the 3D space, wherein the at least one second landmark is non-coplanar to each other; and
matching the at least one first landmark with the at least one second landmark to obtain the corresponding relationship between the at least one first landmark and the at least one second landmark.

8. The spine image registration method according to claim 7, wherein before the step of selecting the third vertebral bodies in the at least one first vertebral body, the method further comprises:
selecting a fifth vertebral body in the at least one first vertebral body, wherein the fifth vertebral body comprises a first reference point located on the first reference line, and a coordinate value of the first reference point in a second dimension is greater than coordinate values of other reference points on the first reference line in the second dimension; and
selecting the third vertebral bodies including the fifth vertebral body based on the fifth vertebral body,
wherein before the step of selecting the fourth vertebral bodies in the at least one second vertebral body, the method further comprises:
selecting a sixth vertebral body in the at least one second vertebral body, wherein the sixth vertebral body comprises a second reference point located on the second reference line, and a coordinate value of the second reference point in the second dimension is greater than coordinate values of other reference points on the second reference line in the second dimension; and
selecting the fourth vertebral bodies including the sixth vertebral body based on the sixth vertebral body.

9. The spine image registration method according to claim 1, wherein the step of performing the registration on the first CT image and the first MRI image comprises:
performing a global registration and a local registration on the first CT image and the first MRI image.

10. The spine image registration method according to claim 9, wherein the global registration comprises a SVD (Singular Value Decomposition) algorithm, and the local registration comprises at least one of Affine Transformation and B-Spline Transformation.
